(19) United States
(12) Patent Application Publication
(10) Pub. No.: US 2021/0062414 A1
(43) Pub. Date: Mar. 4, 2021

(54) TENSION MEMBER AND BELT FOR ELEVATOR SYSTEM

(71) Applicant: Otis Elevator Company, Farmington, CT (US)

(72) Inventor: Chen Qian Zhao, Newark, DE (US)

(21) Appl. No.: 16/556,904

(22) Filed: Aug. 30, 2019

(51) Int. Cl. D07B 1/10; D07B 1/06; D07B 1/16

(52) U.S. Cl. CPC D07B 1/10; D07B 1/0686; D07B 2501/2007; D07B 2205/3025; D07B 1/162

(57) ABSTRACT

A tension member for an elevator system includes a rope formed from a plurality of steel fibers extending along the length of the tension member. A coating at least partially encapsulates the rope. The coating includes a core/shell block copolymer composition. The tension member can be used in a belt and the belt can be used in an elevator system.

### BACKGROUND

Embodiments disclosed herein relate to elevator systems, and more particularly to load bearing members to suspend and/or drive elevator cars of an elevator system.

Elevator systems are useful for carrying passengers, cargo, or both, between various levels in a building. Some elevators are traction based and utilize load bearing members such as belt, ropes or cables for supporting the elevator car and achieving the desired movement and positioning of the elevator car.

Where a belt is used as a load bearing member, a plurality of tension members are embedded in a common jacket. The jacket retains the tension members in desired positions and provides a frictional load path. In an exemplary traction elevator system, a machine drives a traction sheave with which the belts interact to drive the elevator car along a hoistway. Belts typically utilize tension members formed from steel elements.

### BRIEF DESCRIPTION

In one embodiment, a tension member for an elevator system includes a rope formed from a plurality of steel fibers extending along the length of the tension member. A coating at least partially encapsulates the rope. The coating includes a core/shell block copolymer composition.

Additionally or alternatively, in this or other embodiments, the core/shell block copolymer composition comprises a core/shell block copolymer, optional nanoparticles and an optional cross linking agent.

Additionally or alternatively, in this or other embodiments, the core/shell block copolymer composition comprises 60 to 100 weight percent of the core shell block copolymer and 0.5 to 20 weight percent of the nanoparticles, based on the total weight of the core/shell block copolymer composition.

Additionally or alternatively, in this or other embodiments, the coating has a thickness of 0.005 to 1 millimeter.

Additionally or alternatively, in this or other embodiments, the coating completely encapsulates the rope.

In one embodiment, a belt for an elevator system includes a plurality of tension members arranged along a belt width and extending longitudinally along a length of the belt and a jacket at least partially enclosing the plurality of tension members. The tension member includes a rope formed from a plurality of steel fibers extending along the length of the tension member. A coating at least partially encapsulates the rope. The coating includes a core/shell block copolymer composition.

Additionally or alternatively, in this or other embodiments, the core/shell block copolymer composition comprises a core/shell block copolymer, optional nanoparticles and an optional cross linking agent.

Additionally or alternatively, in this or other embodiments, the core/shell block copolymer composition comprises 60 to 100 weight percent of the core shell block copolymer and 0.5 to 20 weight percent of the nanoparticles, based on the total weight of the core/shell block copolymer composition.

Additionally or alternatively, in this or other embodiments, the coating has a thickness of 0.005 to 1 millimeter.

Additionally or alternatively, in this or other embodiments, the coating completely encapsulates the rope.

In another embodiment, an elevator system includes a hoistway, an elevator car located in the hoistway and movable therein, and a belt operably connected to the elevator car to suspend and/or drive the elevator car along the hoistway. The belt includes a plurality of tension members arranged along a belt width and extending longitudinally along a length of the belt, and a jacket at least partially enclosing the plurality of tension members. The tension members include a rope formed from a plurality of steel fibers extending along the length of the tension member. A coating at least partially encapsulates the rope. The coating includes a core/shell block copolymer composition.

Additionally or alternatively, in this or other embodiments, the core/shell block copolymer composition comprises a core/shell block copolymer, optional nanoparticles and an optional cross linking agent.

Additionally or alternatively, in this or other embodiments, the core/shell block copolymer composition comprises 60 to 100 weight percent of the core shell block copolymer and 0.5 to 20 weight percent of the nanoparticles, based on the total weight of the core/shell block copolymer composition.

Additionally or alternatively, in this or other embodiments, the coating has a thickness of 0.005 to 1 millimeter.

Additionally or alternatively, in this or other embodiments, the coating completely encapsulates the rope.

### BRIEF DESCRIPTION OF THE DRAWINGS

The following descriptions should not be considered limiting in any way. With reference to the accompanying drawings, like elements are numbered alike:

FIG. 1 is a schematic illustration of an embodiment of an elevator system;

FIG. 2 is cross-sectional view of an embodiment of a belt for an elevator system; and

FIG. 3 is a cross-sectional view of an embodiment of a tension member for a belt for an elevator system.

### DETAILED DESCRIPTION

A detailed description of one or more embodiments of the disclosed apparatus and method are presented herein by way of exemplification and not limitation with reference to the Figures.

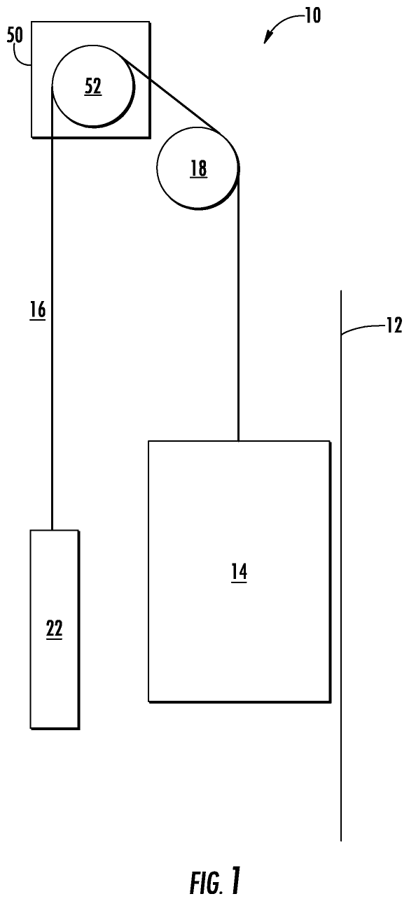

Shown in FIG. 1 is a schematic view of an exemplary traction elevator system 10. Features of the elevator system 10 that are not required for an understanding of the present invention (such as the guide rails, safeties, etc.) are not discussed herein. The elevator system 10 includes an elevator car 14 operatively suspended or supported in a hoistway 12 with one or more load bearing members, such as belts 16. It is to be appreciated that while the present description is in the context of belts 16 as load bearing members, the present disclosure may be applied to other load bearing members, such as cables or ropes.

The one or more belts 16 interact with sheaves 18 and 52 to be routed around various components of the elevator system 10. Sheave 18 is configured as a diverter, deflector or idler sheave and sheave 52 is configured as a traction sheave 52, driven by a machine 50. Movement of the traction sheave 52 by the machine 50 drives, moves and/or propels (through traction) the one or more belts 16 that are routed around the traction sheave 52. Diverter, deflector or idler sheaves 18 are not driven by a machine 50, but help guide the one or more belts 16 around the various components of the elevator system 10. The one or more belts 16 could also be connected to a counterweight 22, which is used to help balance the elevator system 10 and reduce the difference in belt tension on both sides of the traction sheave during operation. The sheaves 18 and 52 each have a diameter, which may be the same or different from each other.

In some embodiments, the elevator system 10 could use two or more belts 16 for suspending and/or driving the elevator car 14. In addition, the elevator system 10 could have various configurations such that either both sides of the one or more belts 16 engage the sheaves 18, 52 or only one side of the one or more belts 16 engages the sheaves 18, 52. The embodiment of FIG. 1 shows a 1:1 roping arrangement in which the one or more belts 16 terminate at the car 14 and counterweight 22, while other embodiments may utilize other roping arrangements.

The belts 16 are constructed to meet belt life requirements and have smooth operation, while being sufficiently strong to be capable of meeting strength requirements for suspending and/or driving the elevator car 14 and counterweight 22.

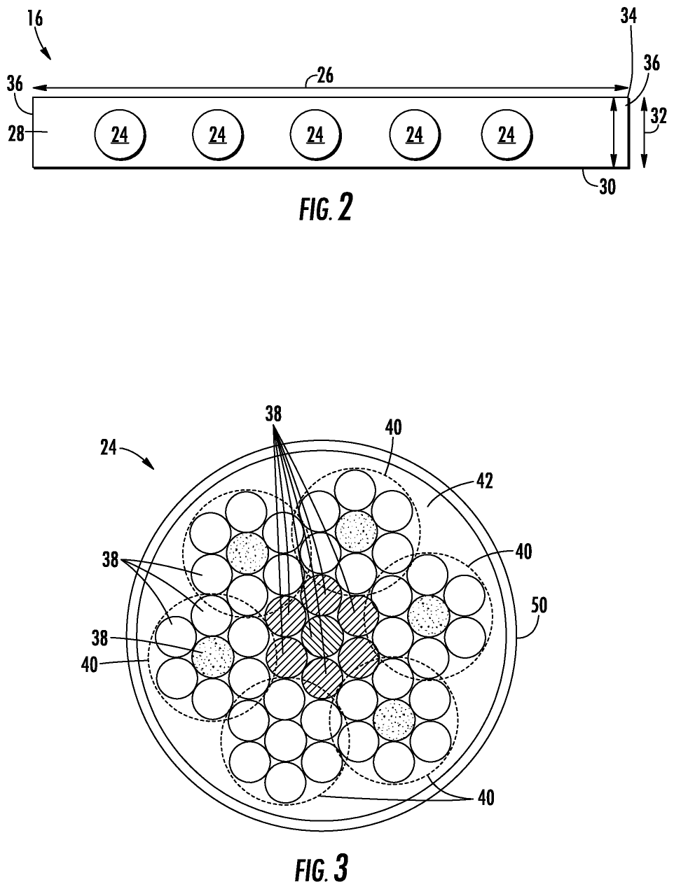

FIG. 2 provides a cross-sectional schematic of an exemplary belt 16 construction or design. The belt 16 includes a plurality of tension members 24 extending longitudinally along the belt 16 and arranged across a belt width 26. The tension members 24 are at least partially enclosed in a jacket 28 to restrain movement of the tension members 24 in the belt 16 and to protect the tension members 24. The jacket 28 defines a traction side 30 configured to interact with a corresponding surface of the traction sheave 52. A primary function of the jacket 28 is to provide a sufficient coefficient of friction between the belt 16 and the traction sheave 52 to produce a desired amount of traction therebetween. The jacket 28 should also transmit the traction loads to the tension members 24. In addition, the jacket 28 should be wear resistant and protect the tension members 24 from impact damage, exposure to environmental factors, such as chemicals, for example.

The belt 16 has a belt width 26 and a belt thickness 32, with an aspect ratio of belt width 26 to belt thickness 32 greater than one. The belt 16 further includes a back side 34 opposite the traction side 30 and belt edges 36 extending between the traction side 30 and the back side 34. While five tension members 24 are illustrated in the embodiment of FIG. 2, other embodiments may include other numbers of tension members 24, for example, 6, 8, 10 or 12 tension members 24. Further, while the tension members 24 of the embodiment of FIG. 2 are substantially identical, in other embodiments, the tension members 24 may differ from one another.

In some embodiments, the jacket 28 is formed from materials such as polyurethanes, polyesters, ethylene propylene diene elastomer, chloroprene, chlorosulfonyl polyethylene, ethylene vinyl acetate, polyamide, polypropylene, butyl rubber, acrylonitrile butadiene rubber, styrene butadiene rubber, acrylic elastomer, fluoroelastomer, silicone elastomer, polyolefin elastomer, styrene block and diene elastomer, natural rubber, or combinations thereof.

Referring now to FIG. 3, the tension member 24 includes a plurality of steel wires 38, which in some embodiments are formed into one or more strands 40. The wires and/or strands are formed into a rope 42. A coating 50 is disposed around rope 42.

The coating 50 is formed from a core/shell block copolymer composition. The core/shell block copolymer composition includes a core/shell block copolymer, optional nanoparticles and an optional cross linking agent. Exemplary core/shell block copolymers include, but are not limited to, polymers formed from the following monomers: methyl methacrylate (MMA), methyl acrylate, butyl methacrylate, butyl acrylate (BA), 2-ethylhexyl acrylate (EHA), 2-ethylhexyl methacrylate, methyl acrylic acid, acrylic acid, methyl acrylamide, glycidyl acrylate glycidyl methacrylate (GMA), and styrene. The core/shell block copolymer is present in an amount of 60 to 100 weight percent based on the total weight of the core/shell block copolymer composition.

Nanoparticles are defined as having no linear dimension greater than 1 micrometer. Exemplary nanoparticles include metals, metal oxides, silicon carbide, and combinations thereof. The nanoparticles may have a surface coating which improves interaction with the core/shell block copolymer. The nanoparticles may be present in an amount of 0.5 to 20 weight percent, based on the total weight of the core/shell block copolymer composition.

Exemplary cross linking agents include epoxy compounds, melamine, silanes, epoxy silanes, carbodiimides, and combinations thereof. The cross linking agent may be present in an amount of 0 to 20 weight percent, based on the total weight of the core/shell block copolymer composition.

The coating 50 is an environmentally friendly alternative to zinc plating which is usually employed on the steel wires and filaments within the wires. The coating 50 protects the steel wires from corrosion and fretting. The coating 50 may be applied using dip coating or similar process. The coating may have a thickness of 0.005 to 1 millimeter (mm), or preferably 0.01 to 0.5, more preferably 0.025 to 0.2.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A tension member for an elevator system comprises a rope formed from a plurality of steel fibers extending along the length of the tension member, wherein a coating at least partially encapsulates the rope and the coating comprises a core/shell block copolymer composition.

2. The tension member of claim 1, wherein the core/shell block copolymer composition comprises a core/shell block copolymer.

3. The tension member of claim 1, wherein the core/shell block copolymer composition comprises a core/shell block copolymer and nanoparticles.

4. The tension member of claim 1, wherein the core/shell block copolymer composition comprises a core/shell block copolymer and a cross linking agent.

5. The tension member of claim 1, wherein the core/shell block copolymer composition comprises a core/shell block copolymer, nanoparticles, and a cross linking agent.

6. The tension member of claim 3, wherein the core/shell block copolymer composition comprises 60 to 100 weight percent of the core shell block copolymer and 0.5 to 20 weight percent of the nanoparticles, based on the total weight of the core/shell block copolymer composition.

7. The tension member of claim 1, wherein the coating has a thickness of 0.005 to 1 millimeter.

8. The tension member of claim 1, wherein the coating completely encapsulates the rope.

9. A belt for an elevator system comprises a plurality of tension members arranged along a belt width and extending longitudinally along a length of the belt and a jacket at least partially enclosing the plurality of tension members, wherein the tension member comprises a rope formed from a plurality of steel fibers extending along the length of the tension member and a coating at least partially encapsulating the rope, and further wherein the coating comprises a core/shell block copolymer composition.

10. The belt of claim 9, wherein the core/shell block copolymer composition comprises a core/shell block copolymer and optional nanoparticles.

11. The belt of claim 10, wherein the core/shell block copolymer composition further comprises a cross linking agent.

12. The belt of claim 10, wherein the core/shell block copolymer composition comprises 60 to 100 weight percent of the core shell block copolymer and 0.5 to 20 weight percent of the nanoparticles, based on the total weight of the core/shell block copolymer composition.

13. The belt of claim 9, wherein the coating has a thickness of 0.005 to 1 millimeter.

14. The belt of claim 9, wherein the coating completely encapsulates the rope.

15. An elevator system comprising a hoistway, an elevator car located in the hoistway and movable therein, and a belt operably connected to the elevator car to suspend and/or drive the elevator car along the hoistway, wherein the belt includes a plurality of tension members arranged along a belt width and extending longitudinally along a length of the belt, and a jacket at least partially enclosing the plurality of tension members and the tension members comprise a rope formed from a plurality of steel fibers extending along the length of the tension member and a coating at least partially encapsulates the rope, wherein the coating comprises a core/shell block copolymer composition.

16. The elevator system of claim 15, wherein the core/shell block copolymer composition comprises a core/shell block copolymer and nanoparticles.

17. The elevator system of claim 15, wherein the core/shell block copolymer composition further comprises a cross linking agent.

18. The elevator system of claim 16, wherein the core/shell block copolymer composition comprises 60 to 100 weight percent of the core shell block copolymer and 0.5 to 20 weight percent of the nanoparticles, based on the total weight of the core/shell block copolymer composition.

19. The elevator system of claim 13, wherein the coating has a thickness of 0.005 to 1 millimeter.

20. The elevator system of claim 13, wherein the coating completely encapsulates the rope.
